(19) United States
(12) Patent Application Publication
(10) Pub. No.: US 2004/0073887 A1
(43) Pub. Date: Apr. 15, 2004

(54) Generating a request log of requests received by a workflow management system

(76) Inventors: Frank Leymann, Aidlingen (DE); Dieter Roller, Schocnaich (DE)

Correspondence Address: A Bruce Clay, IBM Corporation, P O Box 12195, T81 503, Research Triangle Park, NC, 27709, US

(21) Appl. No.: 10/467,529

(22) PCT Filed: Feb. 10, 2001
(86) PCT No.: PCT/EP02/00164

(30) Foreign Application Priority Data
Feb. 10, 2001 (EP) 01103163.0

(51) Int. Cl. G06F 9/44

(52) U.S. Cl. 717/103

(57) ABSTRACT

A workflow management system receives requests, in particular, queries concerning the state of a business process. The workflow management system generates entries into a request log for all received requests.

### TECHNICAL FIELD OF THE INVENTION

The present invention relates in general to a method of operating a workflow management system for managing a business process, and in particular wherein the workflow management system receives queries concerning the state of the business process.

### BACKGROUND OF THE INVENTION

A workflow management system manages, e.g. an order process, which may be initiated by a customer via the Internet. Often, the customer wants some information about the current state of the business process or may even want to terminate the business process. For that purpose, the customer can send appropriate requests to the workflow management system.

It would be advantageous if it were possible to evaluate all requests with respect to statistical information. As an example, it would be advantageous to evaluate the time after which customers typically ask the first time for the state of the business process. With this information, it would be possible to automatically inform the customer about this state before they request this information.

### SUMMARY OF THE INVENTION

It is, therefore, an object of the invention to provide a method of operating a computer system such that it is possible to evaluate all requests in order to generate desired statistical information and/or take appropriate actions.

This object is solved by the invention with the step of generating a log of the requests received by the workflow management system.

According to the invention, an independent request log is generated by the workflow management system. This means that the desired statistical information does not need to be collected and evaluated from a number of different locations of the computer system, as all this statistical information can be entirely obtained from the request log produced by the workflow management system. No further collection of data is necessary, and the establishment of the statistical information is simplified.

It is advantageous if the workflow management system generates an entry in the request log for each of the received requests. It is preferable to be able to specify that the workflow management system only generates entries for particular requests, such as queries for the state of a business process or the termination of a business process.

It is further preferable to be able to specify that the workflow management system generates an entry in the request log only if the targeted business process has certain properties. With this approach it is possible to collect only those received requests in the request log which are really of interest, for example, orders with a low value may be excluded from the request log.

The generation of the request log may preferably be done by the workflow management system similar to the generation of an audit trail by the workflow management system. As a result, the request log is independent from the audit trail and therefore complete in itself. This has the advantage that it is sufficient to access only the request log for obtaining the appropriate information and/or creating the desired statistical information.

### BRIEF DESCRIPTION OF THE DRAWINGS

For a more complete understanding of the present invention and for further advantages thereof, reference is now made to the following Detailed Description taken in conjunction with the accompanying drawings, in which:

FIG. 1 shows a schematic diagram of a business process; and

FIG. 2 shows a computer system for performing an Internet based business process.

### DETAILED DESCRIPTION OF THE INVENTION

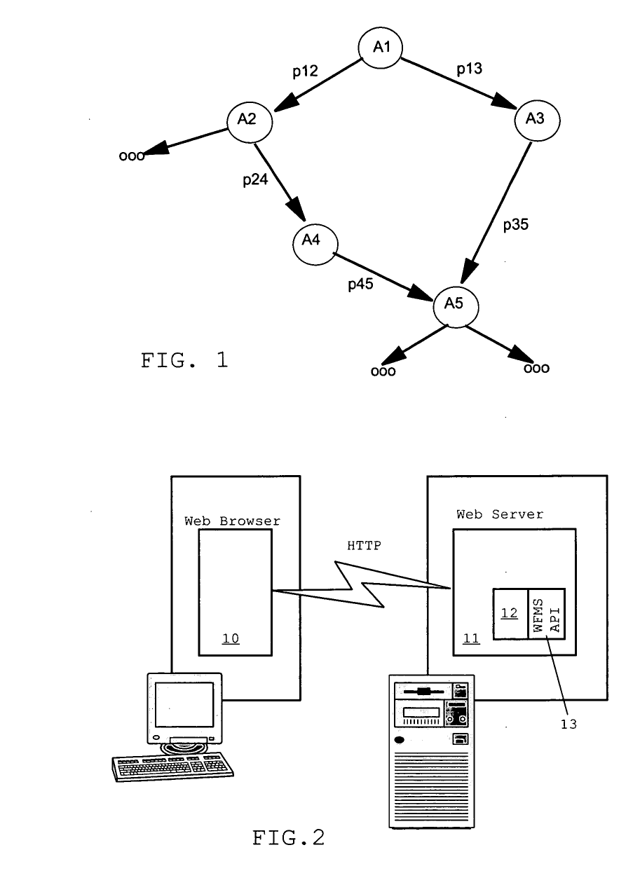

FIG. 1 shows a business process modeled as a graph comprising activities and control connectors. The activities are shown as named circles and describe the tasks to be performed. The control connectors are shown as directed edges and describe the sequence in which the activities are to be carried out. See F. Leymann and D. Roller, Production Workflow: Concepts and Techniques, published by Prentice-Hall, for further information.

Such a business process as schematically depicted in FIG. 1, may be used to process a customer order from its beginning until the delivery of the ordered product by the supplier. The business process may be performed and managed by a computerized workflow management system on the basis of the graphs shown in FIG. 1. For the purpose of specifying a business process, the workflow management system provides a definition language that defines the business process based on the above-mentioned activities and control connectors.

In an Internet environment, it is typical for customers to start a business process or to enter queries concerning the status of the business process by using a web browser. This type of support for end users is typically categorized under the notion of Consumer-to-Business (C2B).

FIG. 2 shows a computer system for interacting with business processes via the Internet. On the left hand side, a customer's web browser 10 is shown. The web browser 10 is connected over the Internet to a web server 11 shown on the right hand side of FIG. 2. The web server 11 interacts with a workflow management system (WFMS) 13 via an application programming interface (API) 12 offered by the workflow management system 13. One typical method of supplying the API in a web server environment is to have the API exposed as Java Beans. The workflow management system 13 is provided to manage the entire business process. The workflow management system 13 may be hosted by the web server 11, but may also reside outside of the web server 11.

Based on the computer system of FIG. 2, the customer may start a business process, e.g. by placing an order via the Internet to the supplier. The customer may also enter a query to obtain e.g. a list of running business processes, the state of a specific business process, or the state of a particular activity within a business process.

The workflow management system 13 responds to these requests by starting the respective business process or by providing responses to the customer queries, respectively. As part of processing a business process, the workflow management system 13 generates, if so specified, an audit trail, containing a complete history of the execution of the business process, such as which steps have been carried out when and by whom.

Furthermore, the workflow management system 13 generates a request log of all requests received from all customers. This request log comprises an entry for each of the received requests as well as specific data associated with the business process, for which the request was issued. It is emphasized that the aforementioned request log is not generated by the web server 11, but by the workflow management system 13.

If the customer queries e.g. the state of the delivery activity within an order process, a corresponding entry of the request log may read as follows: customer name, customer number, state of delivery activity, time, date, other business process properties. Of course, the contents of the request log may also deviate from the above example and may comprise other and/or additional data.

The request log is different from the audit trail. In particular, the request log is complete in itself and, therefore, independent of the audit trail. Only under specific circumstances, is it possible that the information in the request log can be obtained from parts of the audit trail.

The realization of the request log may be done similarly to the realization of the audit trail. E.g., a set of definitions may be provided which extend the definition language of the workflow management system 13.

If the IBM MQSeries Workflow (IBM and Workflowsoftware's Flow definition Language is used, the following definitions request the writing of a request log by the workflow management system 13:

PROCESS OrderProcess

REQUEST_RECORDING

END OrderProcess

These definitions indicate to the workflow management system 13 to store all requests received for the “OrderProcess” business process in the request log.

If it were only necessary to record queries for the “OrderProcess” business process, the following definition would be applicable:

PROCESS OrderProcess

REQUEST_RECORDING REQUESTS=(QUERY)

END OrderProcess

These statements indicate to the workflow management system 13 that of the requests for “OrderProcess” business processes, only queries are recorded in the request log.

If it were only necessary to record queries for high value business processes, the following definitions would be applicable:

STRUCTURE LoanProcessInput

LoanAmount LONG

END LoanProcessInput
PROCESS LoanProcess

(LoanProcessInput,)
REQUEST_RECORDING REQUESTS=(QUERY)

Input.LoanAmount > 10000$

END LoanProcess

These definitions indicate to the workflow management system 13 to store only those requests received for “LoanProcess” business processes in the request log where the value associated with the business process, for which the command was issued, exceeds $10,000. When a request is processed, the workflow management system 13 checks the contents of the LoanAmount field, which contains the loan amount. If the content of this field exceeds $10,000, the request is stored in the request log. Otherwise, no action is performed. Of course, other properties of the request and/or of the customer may also be checked alternatively or additionally before a request is stored in the request log.

The request log may be used by the workflow management system 13 or by other systems to establish, for example, the following statistical information:

The time after which customers typically inquire about the state of their business processes and/or the state the business processes are typically in;

The correlation between the customer properties, such as age or spending behavior, and the number of times the customer inquires; and

The correlation between the value of the business process, such as the amount of the order, and the time the first query comes in.

This information may then be used to perform the following tasks manually and/or automatically by the workflow management system 13 or by other systems:

The customer can be informed about the state of the business process before the first query comes in. The point of time of this information may be estimated based on the customer properties, the business process properties, and so on.

The customer can be informed of the expected time of delivery. This time might be estimated again based on customer and/or business process properties.

1. A method of operating a computer system, wherein said computer system comprises a workflow management system (13) for managing a business process, wherein the workflow management system (13) receives requests for the business process, and wherein the workflow management system (13) generates a request log of the received requests.

2. The method of claim 1, wherein said computer system comprises a web server (11) and at least one web client, wherein the web server (11) comprises a connection to the workflow management system (13), and wherein the web server (11) receives the requests from the at least one web client and forwards the requests to the workflow management system (13).

3. The method of claim 2, wherein the at least one web client is a web browser (10).

4. The method of claim 3, wherein the workflow management system (13) generates an entry in the request log for each of the received requests.

5. The method of claim 4, wherein the workflow management system (13) generates an entry in the request log for only certain types of requests.

6. The method of claim 5, wherein the workflow management system (13) generates an entry in the request log only if a targeted business process or a request issuer has certain properties.

7. The method of claim 6, wherein the realization of the request log is performed similar to the realization of an audit trail of the workflow management system (13).

8. The method of claim 7, wherein the workflow management system (13) responds to the requests.

9. A computer program product, which is suitable to perform the method of claim 8 when loaded into a computer.

10. A computer system comprising a workflow management system (13) for managing a business process, wherein the workflow management system (13) is able to receive requests for said business process, and wherein the workflow management system (13) comprises means for generating a request log of the received requests.
